(19) United States
(12) Patent Application Publication
(10) Pub. No.: US 2018/0174566 A1
(43) Pub. Date: Jun. 21, 2018

(54) COMPACT ACOUSTIC RESONATOR FOR ENCLOSED SYSTEMS

(71) Applicants: Caterpillar Inc., Peoria, IL (US); Brigham Young University, Provo, UT (US)

(72) Inventors: David Charles Copley, Peoria, IL (US); Scott David Sommerfeldt, Mapleton, UT (US); Matthew Franklin Calton, Fletcher, NC (US)

(73) Assignees: Caterpillar Inc., Peoria, IL (US); Brigham Young University, Provo, UT (US)

(21) Appl. No.: 15/678,625

(22) Filed: Aug. 16, 2017

Related U.S. Application Data
(60) Provisional application No. 62/436,125, filed on Dec. 19, 2016.

(51) Int. Cl. G10K 11/04

(52) U.S. Cl. CPC G10K 11/04

(57) ABSTRACT

A noise reduction system includes an enclosed system in which undesirable acoustic noise is generated by one or more associated noise-generating subsystems, and an acoustic resonator mounted on an exterior wall of the enclosed system, with an opening being defined through the exterior wall to allow for the passage of sound pressure waves from within the enclosed system to the acoustic resonator. The acoustic resonator includes a neck connected to the exterior wall at the opening and through which sound pressure waves from the enclosed system travel, at least two branches extending off from the neck, and a resonator connected to a distal end of each of the at least two branches.

### TECHNICAL FIELD

The present disclosure relates generally to a compact acoustic resonator, and more particularly, to a compact acoustic resonator for enclosed systems.

### BACKGROUND

In various enclosed systems, such as passenger compartments on vehicles, engine compartments, combustion chambers of turbine engines, HVAC ducts, intake systems, exhaust systems, and hydraulic systems, undesirable pressure or acoustic oscillations (noise) can occur under certain conditions. The tonal noise may range in frequency from about twenty hertz to a few thousand hertz, and may occur due to the operation of various noise generating subsystems such as air induction systems, exhaust systems, and kinetic energy generating systems. In turbine engines, a positive structural means is often designed into the combustion chamber to damp the high frequency vibrations or cancel them out completely. To attenuate the tonal noise within an enclosed system, resonators have been used to address specific frequencies during operation.

A Helmholtz resonator is based on a device created by Hermann von Helmholtz in the 1860s, and works on the phenomenon of air resonance within a cavity. A Helmholtz resonator, in its simplest form, consists of an enclosed volume (e.g., a bulbous cavity) containing air connected via a neck and an opening to the enclosed system with undesirable noise. The opening into the Helmholtz resonator is often referred to as the “mouth”, and the “neck” is the narrow duct leading from the mouth into the enclosed volume. Sound pressure waves within the enclosed system force air into the cavity of the resonator, increasing the pressure within. Once the external driver that forced the air into the cavity is gone, the higher pressure in the cavity will push a small volume of air (plug of air) near the opening back into the enclosed system to equalize the pressure. However, the inertia of the moving plug of air will force the plug into the enclosed system by a small additional distance (beyond that needed to equalize the pressure), thereby rarifying the air inside the cavity. The low pressure within the cavity will now force the plug of air back into the cavity, thereby increasing the pressure within the cavity again. Thus, the plug of air vibrates like a mass on a spring due to the compliance of the air inside the cavity. The magnitude of this vibrating plug of air progressively decreases due to damping and frictional losses. The energy of the pressure wave generated within the enclosed system is thus dissipated by resonance within the Helmholtz resonator. Energy dissipation is optimized by matching the resonance frequency of the resonator to the acoustic mode of the enclosed system that is being excited by the noise generating subsystems. Typically, frequency matching, or “tuning,” of a Helmholtz resonator is accomplished by changing the dimensions of the Helmholtz cavity and opening.

Another type of acoustic resonator is a quarter wave resonator. The quarter wave resonator includes a duct open at one end and closed at the opposite end. As a result of these end conditions, the duct will resonate at a frequency with a wavelength that is approximately four times the length of the duct.

Acoustic ductwork, or waveguide, refers to a series of ducts, or tubes connected in a way that constrains acoustic wave propagation. The ductwork may also perform other functions such as air handling (HVAC), fluid distribution (hydraulic power), intake and exhaust for an internal combustion engine, etc. There may be a primary or main duct, and branches off the main duct. A side branch resonator may be either of the above types of resonators attached to a main duct in a way that they branch to a side of the main duct. In some implementations, the resonators and their basic elements may not be attached to long ductwork. Rather, one or more different types of resonator volumes such as a Helmholtz-type resonator volume, one or more quarter wave-type resonator volumes and a main duct may all be defined by various partitions within a box or other enclosure.

One implementation of a Helmholtz resonator in a gas turbine combustion chamber is described in U.S. Pat. No. 5,431,018 (the '018 patent) issued to Keller on Jul. 11, 1995. The Helmholtz resonator of the '018 patent is disposed around an air shroud that feeds the air necessary for mixing with fuel. Part of the air from the air shroud is bypassed into the Helmholtz resonator using an inlet tube. The Helmholtz resonator is connected to a combustion chamber using a damping tube that is configured as an annular duct around the air shroud. The '018 patent, thus, discloses a single Helmholtz resonator that is formed by a cavity around each fuel injector and connected to the combustion chamber by an annular opening around the injector while being independent of a combustion chamber cooling system of the combustion chamber.

Although the Helmholtz resonator of the '018 patent may assist with attenuating undesirable acoustic instabilities generated within a combustion chamber for a turbine engine, tuning the resonator of the '018 patent to match the natural frequency of the turbine engine may involve redesigning cavity sizes and configurations for various components associated with the combustion chamber and for the Helmholtz resonator. Typically, tuning the Helmholtz resonator to the appropriate frequency is a trial-and-error process that may involve experiments using a number of configurations (cavity volume, size of the opening that connects the cavity to the combustion chamber, etc.) of the resonator. It may be advantageous to provide a compact resonator that can be readily coupled to an enclosed system that experiences undesirable noise while providing a wide acoustic response curve for the resonator such that the resonator is more robust to manufacturing variability.

The present disclosure is directed at overcoming one or more of the shortcomings set forth above.

### SUMMARY

In one aspect, the present disclosure is directed to a noise reduction system including an enclosed system in which undesirable acoustic noise is present and an acoustic resonator mounted on an exterior wall of the enclosed system. An opening is defined through the exterior wall to allow for the passage of sound pressure waves from within the enclosed system to the acoustic resonator. The acoustic resonator includes a neck connected to the exterior wall at the opening and through which sound pressure waves from the enclosed system travel, at least two branches extending off from the neck, and a resonator connected to a distal end of each of the at least two branches.

In another aspect, the present disclosure is directed to an acoustic resonator. The acoustic resonator includes a neck configured to be coupled to an exterior wall of an enclosed system and in fluid communication with an opening through the exterior wall for the passage of sound pressure waves from within the enclosed system to the acoustic resonator, and at least two separate branched acoustic flow passageways extending off from the neck. The acoustic resonator also includes a resonator connected to a distal end of each of the at least two branched acoustic flow passageways.

In a further aspect, the present disclosure is directed to a method of damping acoustic oscillations in an enclosed system. The method may include mounting an acoustic resonator on an exterior wall of the enclosed system, with an opening being defined through the exterior wall of the enclosed system to allow for the passage of sound pressure waves from within the enclosed system to the acoustic resonator. The method may also include connecting one end of a neck of the acoustic resonator to the exterior wall of the enclosed system at the opening, with the acoustic resonator including at least two branches extending off from the neck, and a resonator connected to a distal end of each of the at least two branches.

### BRIEF DESCRIPTION OF THE DRAWINGS

FIG. 1 is a perspective view of an exemplary disclosed noise reduction system including an acoustic resonator mounted on a vehicle passenger compartment;

FIG. 2 is an enlarged perspective view of the exemplary acoustic resonator of FIG. 1;

FIG. 3 is an enlarged perspective view of the neck of the exemplary acoustic resonator of FIGS. 1 and 2; and

FIG. 4 is a schematic drawing representing a system for generating a three-dimensional model of one or more portions of the acoustic resonator of FIGS. 1, 2, and 3.

### DETAILED DESCRIPTION

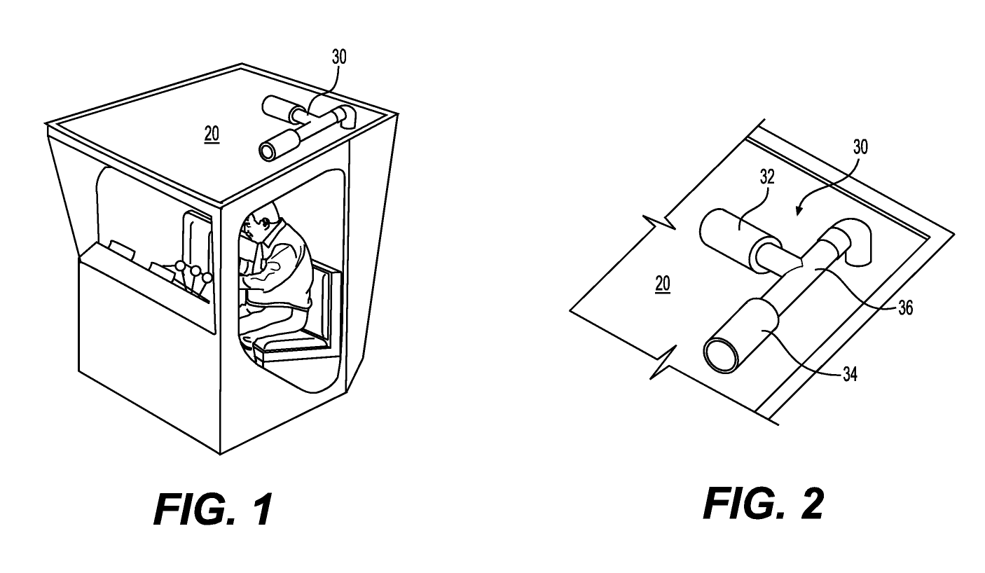

FIG. 1 illustrates an exemplary noise reduction system according to an embodiment of this disclosure. The exemplary noise reduction system includes an enclosed system 20 in which undesirable acoustic noise is present, and an acoustic resonator 30 mounted on an exterior wall of the enclosed system 20. The enclosed system 20 shown in FIG. 1 is a passenger compartment on a vehicle such as an off-highway construction vehicle or earth-moving vehicle. Other exemplary enclosed systems that may benefit from an associated acoustic resonator configured to reduce or eliminate undesirable acoustic noise in the enclosed system include a duct of a HVAC system, an engine compartment, an intake system for a power plant, an exhaust system for a power plant, a combustion system for a power plant, and a hydraulic fluid system.

An opening is defined through an exterior wall of the enclosed system 20 to allow for the passage of sound pressure waves from within the enclosed system to the acoustic resonator 30. In various alternative embodiments of the noise reduction system, more than one acoustic resonator 30 may be connected to one or more exterior walls of the enclosed system. Optimal locations for the one or more acoustic resonators may be determined by the various acoustic modes of the enclosed system, space constraints for location of the acoustic resonators, and the various shapes and configurations of the components of the acoustic resonator. The acoustic modes of the enclosed system may be a function of operational characteristics of the one or more associated noise-generating subsystems. For example, a passenger compartment on a bulldozer may experience the largest amounts of acoustic oscillations during certain ranges of engine RPM, during certain operations, and/or when operating on certain terrains. The acoustic modes of the passenger compartment during these identified periods of operation may be the primary factors in determining the optimal location for the one or more acoustic resonators mounted on one or more exterior walls of the enclosed system. An acoustic resonator according to the present disclosure may be an arrangement of surfaces that form a cavity or series of connected cavities, including at least one opening or mouth through which sound waves may enter and exit. By virtue of its finite geometry, acoustic modes may be induced into resonance within the resonance volumes of the acoustic resonator. Two basic types of acoustic resonators for controlling noise are Helmholtz and quarter wave-type resonators. Various types and quantities of resonator volumes may also be combined in a single or multiple enclosures to produce an acoustic resonator.

The acoustic resonator 30 may include a neck 36 or main duct connected to an exterior wall of the enclosed system 20 at the opening or mouth defined through the wall. The neck 36 may lead to one or more side branched resonator volumes. The acoustic resonator 30 may be manufactured from various materials, including metal, plastic, carbon fiber, ceramics and other suitable materials, the selection of which may depend at least in part on costs of the materials, acoustic qualities of the materials, acoustic resistance characteristics of the interior surfaces of the various components making up the acoustic resonator, strength of the materials, and manufacturability of the materials. One end of the neck 36 may be connected to the wall of the enclosed system 20 at the opening through the wall using different known techniques such as a threaded connection, a chemically bonded connection, and a welded connection. The opening through the wall of the enclosed system and the connection of the acoustic resonator to the opening enable the fluid communication of sound pressure waves from the enclosed system into the acoustic resonator.

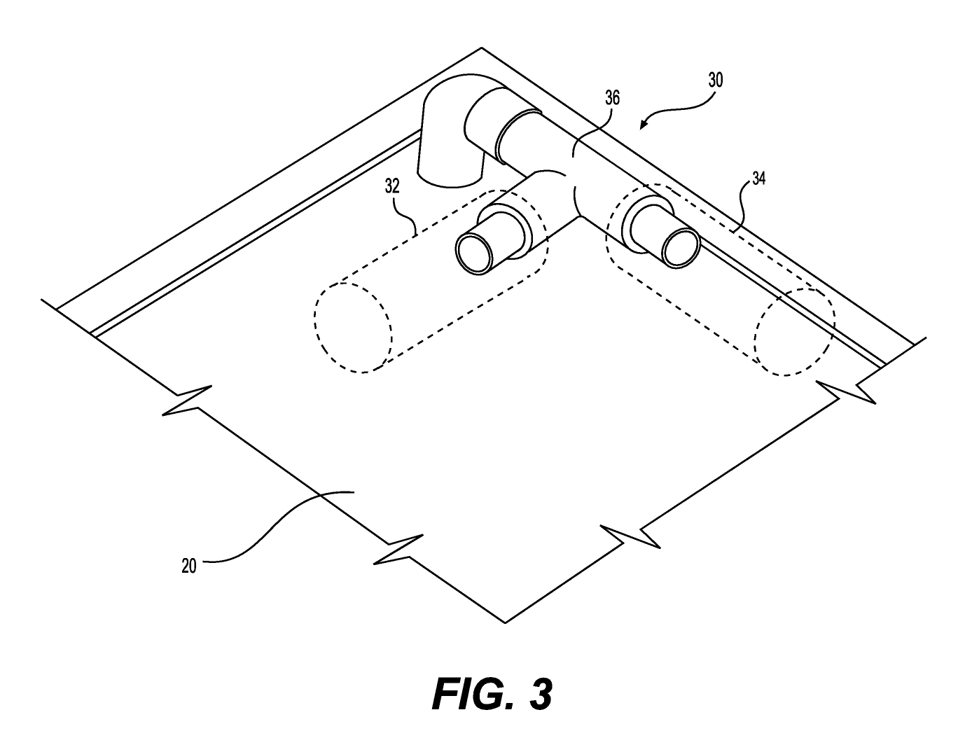

As shown in FIGS. 1-3, the neck 36 of the acoustic resonator 30 may be configured to be fluidly coupled to the opening in the exterior wall of the enclosed system 20 for the passage of sound pressure waves from within the enclosed system to the acoustic resonator. The neck 36 may include at least two branched acoustic flow passageways extending off from the neck. A resonator volume 32 may be connected to a distal end of one of the at least two branches, and another resonator volume 34 may be connected to a distal end of another one of the at least two branches. The resonator volumes 32, 34 may be Helmholtz-type resonators, quarter-wave type resonators, or other resonating chambers. The neck 36 or main duct leading to the resonator volumes may include a first leg configured to extend substantially perpendicular to the exterior wall for a first distance, and a second leg configured to extend substantially parallel to the exterior wall for a second distance. In various alternative embodiments, the lengths and relative global orientations of the first and second legs of the neck 36 relative to the exterior wall of the enclosed system 20 may be varied depending on a variety of factors. Factors affecting the configuration of the acoustic resonator 30 may include the acoustic modes of the enclosed system 20, the desired breadth of acoustic responsiveness of the acoustic resonator 30, the acoustic resistance of various configurations of the acoustic resonator, manufacturability of the acoustic resonator, and space constraints that may limit the overall size and location of the acoustic resonator.

In the exemplary embodiment of the acoustic resonator 30 illustrated in FIGS. 1-3, a central axis of one of the at least two branched passageways extends off from the neck 36 at right angles to a central axis of another of the at least two branched passageways. The neck 36 includes a right-angle section configured for connection to the opening in the exterior wall of the enclosed system 20, and a Tee-shaped section configured for connection to the right-angle section and to two of the resonator volumes 32, 34. Although the exemplary embodiment illustrated in FIGS. 1-3 includes the Tee-shaped section with approximately symmetrical dimensions, alternative embodiments may include an asymmetrical Tee-shaped section with different spacings between one end of the Tee-shaped section and the branches. Alternatively or in addition, central axes of each of the branched passageways may be oriented relative to each other at angles other than right angles, or with at least portions of the branched passageways being oriented substantially parallel to each other with central axes that are offset from each other. Other alternative configurations may include a neck with a Y-shaped section leading to the branched passageways, a U-shaped section, an E-shaped section leading to 3 branched passageways offset from each other and substantially parallel to each other, and other configurations that result in the desired damping effects for sound pressure waves passing into the acoustic resonator from the enclosed system.

The two exemplary resonator volumes 32, 34 shown in FIGS. 1-3 are substantially cylindrical in shape, and are connected at the distal ends of the branched acoustic flow passageways in fluid communication with the enclosed system 20 through the neck 36. Alternative embodiments may include the resonator volumes having different resonance volumes from each other, and different shapes. In various implementations of this disclosure, at least one of the neck 36 and the resonator volumes 32, 34 may be produced by additive manufacturing techniques (3D manufacturing) such that at least some of the interior surfaces of the acoustic resonator have a roughness resulting from the additive manufacturing processes that creates a resistance to acoustic flow in the acoustic resonator. Alternative embodiments may include some or all of the interior surfaces of the acoustic resonator having a smooth surface without any appreciable resistance to acoustic flow caused by the configuration of the interior surfaces. The differences in the resonance volumes of the multiple resonator volumes 32, 34, the configuration and dimensions of the neck 36, the orientations of the resonators relative to each other and to the neck, and the resistances to acoustic flow through the neck 36 and the resonator volumes 32, 34 may be selected in order to produce the desired effects. The desired effects may include the tuning effect of the acoustic resonator (reduction in undesirable acoustic frequencies) and the breadth of responsiveness of the acoustic resonator in effectively damping a range of acoustic oscillations and vibrations within the enclosed system.

In various embodiments of the acoustic resonator according to this disclosure, the neck 36 may include one or more screens or other resistances to acoustic flow (not shown) placed within the neck at a position that also may prevent foreign objects from entering the neck and the resonators. Resistances to acoustic flow in the acoustic resonator, such as internally positioned screens, or surface roughness characteristics on the interior of the neck and/or the resonators may contribute to an increased range of acoustic oscillations that are dampened by the acoustic resonator, also referred to as a broader responsiveness of the acoustic resonator.

### INDUSTRIAL APPLICABILITY

The disclosed acoustic resonator 30 with associated resonator volumes 32, 34 may be applicable to any enclosed system wherein reduced acoustic oscillations within the enclosed system are desired. As discussed above, exemplary enclosed systems may include a vehicle passenger compartment, such as illustrated in FIG. 1, an engine compartment, a duct for use with a HVAC system, an intake system for a power plant (e.g., an internal combustion engine or an external combustion engine), an exhaust system for a power plant, a combustion system for a power plant, and a hydraulic fluid system. The disclosed acoustic resonator 30 with the associated resonator volumes 32, 34 may provide a compact system that can be configured to fit in limited spaces associated with the enclosed system 20 and reduce vibrations by acoustically attenuating sound pressure fluctuations within the enclosed system.

A method of damping acoustic oscillations in an enclosed system according to various implementations of this disclosure may include mounting the acoustic resonator 30 on an exterior wall of the enclosed system 20, with an opening being defined through the exterior wall of the enclosed system to allow for the passage of sound pressure waves from within the enclosed system to the acoustic resonator. The method may include connecting one end of a neck of the acoustic resonator to the exterior wall of the enclosed system at the opening. The acoustic resonator 30 may include at least two branches extending off from the neck, and a resonator volume 32, 34 (such as a Helmholtz-type resonator volume or a quarter-wave type resonator volume) being connected to a distal end of each of the at least two branches. The neck 36 of the acoustic resonator 30 includes a right-angle section configured for connection to the opening in the exterior wall, and a Tee-shaped section configured for connection to the right-angle section and to two of the resonators 32, 34.

At least one of the neck 36 and the resonators 32, 34 may be produced by additive manufacturing such that at least some of the interior surfaces of the acoustic resonator have a roughness (e.g., ridges or striations) from the additive manufacturing process that creates a resistance to acoustic flow in the acoustic resonator. In various alternative implementations of this disclosure, interior surface characteristics such as the ridges, striations, or other characteristics may be machined or otherwise formed into some or all of the interior surfaces of the acoustic resonator. The resonator volumes 32, 34 may also be provided with the same or at least slightly different internal resonance volumes from each other.

The disclosed neck 36 and/or resonators 32, 34 may be manufactured using conventional techniques such as, for example, casting or molding. Alternatively, the disclosed various parts of the acoustic resonator 30 may be manufactured using conventional techniques generally referred to as additive manufacturing or additive fabrication. Known additive manufacturing/fabrication processes include techniques such as, for example, 3D printing. 3D printing is a process wherein material may be deposited in successive layers under the control of a computer. The computer controls additive fabrication equipment to deposit the successive layers according to a three-dimensional model (e.g. a digital file such as an AMF or STL file) that is configured to be converted into a plurality of slices, for example substantially two-dimensional slices, that each define a cross-sectional layer of the parts of the acoustic resonator in order to manufacture, or fabricate, the parts. In one case, the disclosed neck 36 and/or resonators 32, 34 would be an original component and the 3D printing process would be utilized to manufacture the part. In other cases, the 3D process could be used to replicate an existing part of the acoustic resonator and the replicated part could be sold as aftermarket parts. These replicated aftermarket parts could be either exact copies of the original parts or pseudo copies differing in only non-critical aspects.

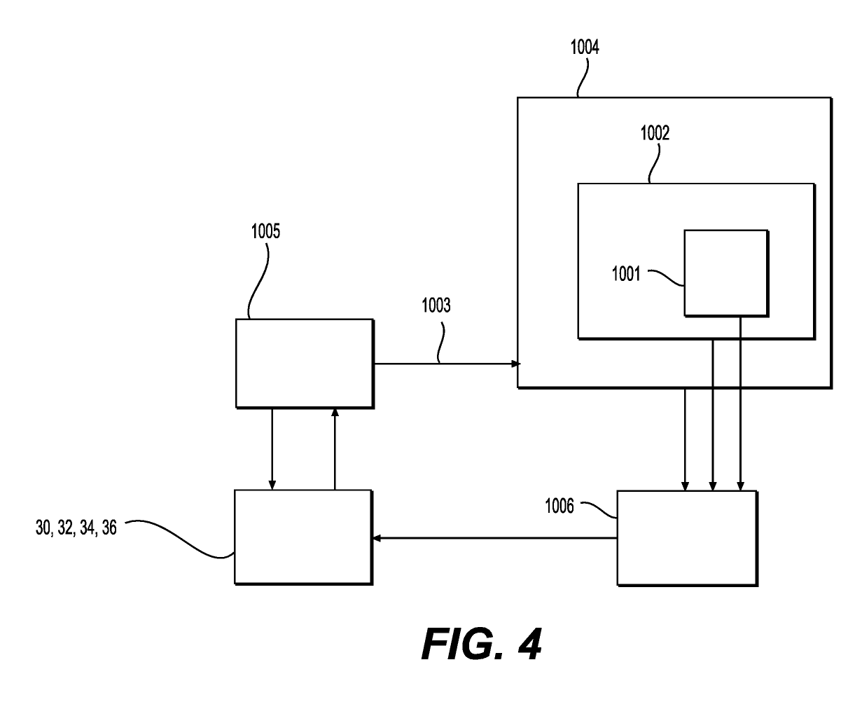

With reference to FIG. 4, the three-dimensional model 1001 used to represent an original part of the acoustic resonator 30 may be on a computer-readable storage medium 1002 such as, for example, magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. This storage medium may be used in connection with commercially available 3D printers 1006 to manufacture, or fabricate, the parts of the acoustic resonator 30. Alternatively, the three-dimensional model may be transmitted electronically to the 3D printer 1006 in a streaming fashion without being permanently stored at the location of the 3D printer 1006. In either case, the three-dimensional model constitutes a digital representation of the parts of the acoustic resonator suitable for use in manufacturing the parts.

The three-dimensional model may be formed in a number of known ways. In general, the three-dimensional model is created by inputting data 1003 representing the part(s) of the acoustic resonator 30 to a computer or a processor 1004 such as a cloud-based software operating system. The data may then be used as a three-dimensional model representing the physical neck 36 and/or resonators 32, 34. The three-dimensional model is intended to be suitable for the purposes of manufacturing the parts of the acoustic resonator 30. In an exemplary embodiment, the three-dimensional model is suitable for the purpose of manufacturing the parts of the acoustic resonator by an additive manufacturing technique.

In one embodiment depicted in FIG. 4, the inputting of data may be achieved with a 3D scanner 1005. The method may involve contacting the desired part of the acoustic resonator 30 via a contacting and data receiving device and receiving data from the contacting in order to generate the three-dimensional model. For example, 3D scanner 1005 may be a contact-type scanner. The scanned data may be imported into a 3D modeling software program to prepare a digital data set. In one embodiment, the contacting may occur via direct physical contact using a coordinate measuring machine that measures the physical structure of the part by contacting a probe with the surfaces of the part in order to generate a three-dimensional model. In other embodiments, the 3D scanner 1005 may be a non-contact type scanner and the method may include directing projected energy (e.g. light or ultrasonic) onto the part to be replicated and receiving the reflected energy. From this reflected energy, a computer would generate a computer-readable three-dimensional model for use in manufacturing the part. In various embodiments, multiple 2D images can be used to create a three-dimensional model. For example, 2D slices of a 3D object can be combined to create the three-dimensional model. In lieu of a 3D scanner, the inputting of data may be done using computer-aided design (CAD) software. In this case, the three-dimensional model may be formed by generating a virtual 3D model of the disclosed part of the acoustic resonator 30 using the CAD software. A three-dimensional model would be generated from the CAD virtual 3D model in order to manufacture the part.

The additive manufacturing process utilized to create the disclosed neck 36 and/or resonators 32, 34 may involve materials such as plastic, rubber, metal, etc. In some embodiments, additional processes may be performed to create a finished product. Such additional processes may include, for example, one or more of cleaning, hardening, heat treatment, material removal, and polishing. Other processes necessary to complete a finished product may be performed in addition to or in lieu of these identified processes.

It will be apparent to those skilled in the art that various modifications and variations can be made to the disclosed acoustic resonator. Other embodiments will be apparent to those skilled in the art from consideration of the specification and practice of the disclosed acoustic resonator and noise reduction system. It is intended that the specification and examples be considered as exemplary only, with a true scope being indicated by the following claims and their equivalents.

What is claimed is:

1. A noise reduction system, comprising:
an enclosed system in which undesirable acoustic noise is present; and
an acoustic resonator mounted on an exterior wall of the enclosed system, an opening being defined through the exterior wall to allow for the passage of sound pressure waves from within the enclosed system to the acoustic resonator, wherein the acoustic resonator includes:
a neck connected to the exterior wall at the opening and through which sound pressure waves from the enclosed system travel;
at least two branches extending off from the neck; and
a resonator connected to a distal end of each of the at least two branches.

2. The noise reduction system of claim 1, wherein the neck includes:
a first leg extending substantially perpendicular to the exterior wall for a first distance; and
a second leg extending substantially parallel to the exterior wall for a second distance.

3. The noise reduction system of claim 1, wherein a central axis of one of the at least two branches extending off from the neck is at right angles to a central axis of another of the at least two branches.

4. The noise reduction system of claim 1, wherein the neck includes a right-angle section configured for connection to the opening in the exterior wall, and a Tee-shaped section configured for connection to the right-angle section and to two of the resonators.

5. The noise reduction system of claim 1, wherein at least one of the neck and the resonators is produced by additive manufacturing such that at least some of the interior surfaces of the acoustic resonator have a roughness from the additive manufacturing process that creates a resistance to acoustic flow in the acoustic resonator.

6. The noise reduction system of claim 1, wherein at least two of the resonators have different internal resonance volumes from each other.

7. The noise reduction system of claim 1, wherein the neck includes a screen placed within the neck at a position that prevents foreign objects from entering the neck and the resonators, and the screen also creates a resistance to acoustic flow in the acoustic resonator while enhancing a range of acoustic oscillations that are dampened by the acoustic resonator.

8. The noise reduction system of claim 1, wherein each of the resonators has a substantially cylindrical shape, and central axes of at least two of the resonators are one of perpendicular to each other or parallel and offset from each other.

9. The noise reduction system of claim 1, wherein the enclosed system is one of a duct of a HVAC system, a passenger compartment, an engine compartment, an intake system for a power plant, an exhaust system for a power plant, and a hydraulic fluid system.

10. An acoustic resonator, comprising:
a neck configured to be coupled to an exterior wall of an enclosed system and in fluid communication with an opening through the exterior wall for the passage of sound pressure waves from within the enclosed system to the acoustic resonator;
at least two separate branched acoustic flow passageways extending off from the neck; and
a resonator connected to a distal end of each of the at least two branched acoustic flow passageways.

11. The acoustic resonator of claim 10, wherein the neck includes:
a first leg configured to extend substantially perpendicular to the exterior wall for a first distance; and
a second leg configured to extend substantially parallel to the exterior wall for a second distance.

12. The acoustic resonator of claim 10, wherein a central axis of one of the at least two branched acoustic flow passageways extends off from the neck at right angles to a central axis of another of the at least two branched acoustic flow passageways.

13. The acoustic resonator of claim 10, wherein the neck includes a right-angle section configured for connection to the opening in the exterior wall, and a Tee-shaped section configured for connection to the right-angle section and to two of the resonators.

14. The acoustic resonator of claim 10, wherein at least one of the neck and the resonators is produced by additive manufacturing such that at least some of the interior surfaces of the acoustic resonator have a roughness from the additive manufacturing process that creates a resistance to acoustic flow in the acoustic resonator.

15. The acoustic resonator of claim 10, wherein at least two of the resonators have different internal resonance volumes from each other.

16. The acoustic resonator of claim 10, wherein the neck includes a screen placed within the neck at a position that prevents foreign objects from entering the neck and the resonators, and the screen also creates a resistance to acoustic flow in the acoustic resonator while enhancing a range of acoustic oscillations that are dampened by the acoustic resonator.

17. The acoustic resonator of claim 10, wherein each of the resonators has a substantially cylindrical shape, and central axes of at least two of the resonators are one of perpendicular to each other or parallel and offset from each other.

18. A method of damping acoustic oscillations in an enclosed system, the method comprising:
mounting an acoustic resonator on an exterior wall of the enclosed system, with an opening being defined through the exterior wall of the enclosed system to allow for the passage of sound pressure waves from within the enclosed system to the acoustic resonator;
connecting one end of a neck of the acoustic resonator to the exterior wall of the enclosed system at the opening;
the acoustic resonator including at least two branches extending off from the neck; and
a resonator being connected to a distal end of each of the at least two branches.

19. The method of claim 18, wherein the neck of the acoustic resonator includes a right-angle section configured for connection to the opening in the exterior wall, and a Tee-shaped section configured for connection to the right-angle section and to two of the resonators.

20. The method of claim 18, wherein at least one of the neck and the resonators is produced by an additive manufacturing process such that at least some of the interior surfaces of the acoustic resonator have a roughness from the additive manufacturing process that creates a resistance to acoustic flow in the acoustic resonator, and wherein at least two of the resonators have different internal resonance volumes from each other.

21. A method of creating a computer-readable three-dimensional model suitable for use in manufacturing at least one of the neck and the resonators of claim 1, the method comprising:
inputting data representing the at least one of the neck and the resonators to a computer; and
using the data to represent the at least one of the neck and the resonators as a three-dimensional model, the three dimensional model being suitable for use in manufacturing the at least one of the neck and the resonators.

22. The method of claim 21, wherein the inputting of data includes one or more of using a contact-type 3D scanner to contact the at least one of the neck and the resonators, using a non-contact 3D scanner to project energy onto the at least one of the neck and the resonators and receive reflected energy, and generating a virtual three-dimensional model of the at least one of the neck and the resonators using computer-aided design (CAD) software.

23. A computer-readable three-dimensional model suitable for use in manufacturing at least one of the neck and the resonators of claim 1.

24. A computer-readable storage medium having data stored thereon representing a three-dimensional model suitable for use in manufacturing at least one of the neck and the resonators of claim 1.

25. A method for manufacturing at least one of the neck and the resonators of claim 1, the method comprising the steps of:
providing a computer-readable three-dimensional model of at least one of the neck and the resonators, the three-dimensional model being configured to be converted into a plurality of slices that each define a cross-sectional layer of the at least one of the neck and the resonators; and
successively forming each layer of the at least one of the neck and the resonators by additive manufacturing.
